(19) United States
(12) Patent Application Publication
(10) Pub. No.: US 2024/0085614 A1
(43) Pub. Date: Mar. 14, 2024

(54) ANTI-PEEP LIGHT SOURCE MODULE AND DISPLAY DEVICE

(71) Applicant: Coretronic Corporation, Hsin-Chu (TW)

(72) Inventors: Yi-Cheng Lin, Hsin-Chu (TW); Chih-Hsuan Kuo, Hsin-Chu (TW); Sung-Chun Hsu, Hsin-Chu (TW); Ming-Hsiung Fan, Hsin-Chu (TW); Tzeng-Ke Shiau, Hsin-Chu (TW)

(73) Assignee: Coretronic Corporation, Hsin-Chu (TW)

(21) Appl. No.: 18/463,322

(22) Filed: Sep. 8, 2023

(30) Foreign Application Priority Data
Sep. 13, 2022 (CN) 202211109687.3

(51) Int. Cl. F21V 8/00

(52) U.S. Cl. CPC G02B 6/0053; G02B 6/0038

(57) ABSTRACT

An anti-peep light source module includes a light source module and a viewing angle switching module. The light source module has a light source and a light guide plate (LGP) and has light emitting elements arranged along a first direction. The viewing angle switching module is located on a transmission path of an illumination beam of the light source module and includes a viewing angle limiting element and a viewing angle adjusting element configured to change a viewing angle of the illumination beam. The viewing angle limiting element has a grating structure and is located between the viewing angle adjusting element and the light source module. an included angle between an extension direction of the grating structure and the first direction is within a range from 88 degrees to 92 degrees. The anti-peep light source module and A display device achieve favorable optical performance, user experience, and production yield.

### CROSS-REFERENCE TO RELATED APPLICATION

This application claims the priority benefit of China application serial no. 202211109687.3, filed on Sep. 13, 2022. The entirety of the above-mentioned patent application is hereby incorporated by reference herein and made a part of this specification.

### BACKGROUND OF THE INVENTION

### 1. Field of the Invention

The invention relates to an optical module and an electronic device and particularly relates to an anti-peep light source module and a display device.

### 2. Description of Related Art

With the development of science and technologies, a display device has become a common electronic device in our daily lives. At present, some display devices provide privacy protection functions to maintain users' viewing privacy. To be specific, since both a liquid crystal display and an electronically controlled liquid crystal viewing angle switch in an existing anti-peep display device are liquid crystal panels, the transmissivity is significantly reduced. Therefore, a backlight module used in the anti-peep display device usually has an architecture that has a high optical performance and may maximize a forward brightness to reduce system power consumption.

Thereby, however, a viewing angle of the anti-peep display device in a vertical direction of a user's vision is apparently smaller than that of a normal display device without the anti-peep function, thus affecting the user experience of the anti-peep display device. In addition, the architecture with the high optical performance aim at maximizing the optical performance, and thus an overall optical path of said architecture encounters a scattering issue to a less extent, and thus a flaw concealing property is compromised, which may easily lead to an apparent optical flaw on a display image. Hence, such an architecture has relatively high requirements for production quality and thus may have a reduced projection yield.

Accordingly, how to take into account all of the optical performance, the user experience, and the production yield of the anti-peep display device is an important issue.

The information disclosed in this Background section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY OF THE INVENTION

One or more embodiments of the invention provide an anti-peep light source module and a display device which may achieve favorable optical performance, user experience, and production yield.

Other objectives and advantages of the invention may be further understood from the technical features disclosed in the invention.

In order to achieve one, some, or all of the aforementioned objectives or other objectives, an embodiment of the invention provides an anti-peep light source module. The anti-peep light source module includes a light source module and a viewing angle switching module. The light source module has a light source and a light guide plate (LGP). The light source is configured to provide a light beam and has a plurality of light emitting elements arranged along a first direction. The first direction is parallel to a light incidence surface of the LGP. The LGP has a plurality of optical microstructures on a first surface of the LGP, the light beam leaves a second surface of the LGP through optical surfaces of the optical microstructures of the LGP and generates an illumination beam, and the light incidence surface is located between the first surface and the second surface. The viewing angle switching module is located on a transmission path of the illumination beam and includes a viewing angle limiting element, and a viewing angle adjusting element. The viewing angle limiting element has a grating structure, where an included angle between an extension direction of the grating structure and the first direction is within a range from 88 degrees to 92 degrees. The viewing angle adjusting element is configured to change a viewing angle range of the illumination beam, where the viewing angle limiting element is located between the viewing angle adjusting element and the light source module.

In order to achieve one, some, or all of the aforementioned objectives or other objectives, an embodiment of the invention provides a display device that includes the anti-peep light source module and a display panel. The display panel is located on the transmission path of the illumination beam and located on one side of the viewing angle limiting element away from the LGP.

In view of the above, in the anti-peep light source module and the display device provided in one or more embodiments of the invention, the configuration of the range of a light receiving angle of the optical microstructures of the LGP allows the illumination beam to have an enhanced brightness of the illumination beam within the viewing angle range in various directions of the display device, and the vision of users may be accordingly expanded. Moreover, the illumination beam may have a relatively large forward luminance within the viewing angle range in a horizontal direction of the display device through the arrangement of the viewing angle limiting element and, at the same time, the brightness of the illumination beam within the viewing angle range in a vertical direction of the display device is not deteriorated. Besides, the viewing angle range may be switched between a normal mode and an anti-peep mode through the viewing angle adjusting element. Thereby, the optical performance and the user experience of the anti-peep light source module may be taken into consideration. Moreover, through the arrangement of at least one optical film with an appropriate haze, the anti-peep light source module and the display device provided in one or more embodiments of the invention may take into account the requirements for the brightness and the flaw concealing property and at the same time achieve the favorable optical performance and the satisfactory production yield. As such, the anti-peep light source module and the display device provided in one or more embodiments of the invention may achieve the favorable optical performance, the user experience, and the production yield.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic front view of a display device according to an embodiment of the invention.

FIG. 2 is a schematic cross-sectional view of the display device depicted in FIG. 1 in a vertical direction.

FIG. 3 is a schematic cross-sectional view of the display device depicted in FIG. 1 in a horizontal direction.

FIG. 4A and FIG. 4B are curve diagrams illustrating a relationship between a viewing angle and a brightness of the display device depicted in FIG. 1 and a viewing angle and a brightness of a display device in a comparison example in a horizontal direction and a vertical direction when the display devices are in a normal mode.

FIG. 4C and FIG. 4D are curve diagrams illustrating the relationship between the viewing angle and the brightness of the display device depicted in FIG. 1 and the viewing angle and the brightness of the display device in the comparison example in the horizontal direction and the vertical direction when the display devices are in an anti-peep mode.

FIG. 5 is a schematic structural view of a display device according to another embodiment of the invention.

FIG. 6 is a schematic structural view of a display device according to still another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

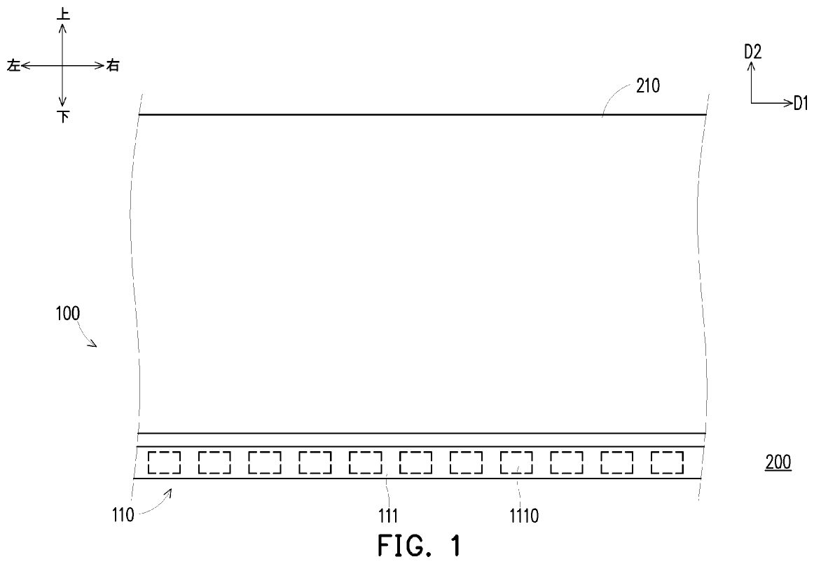

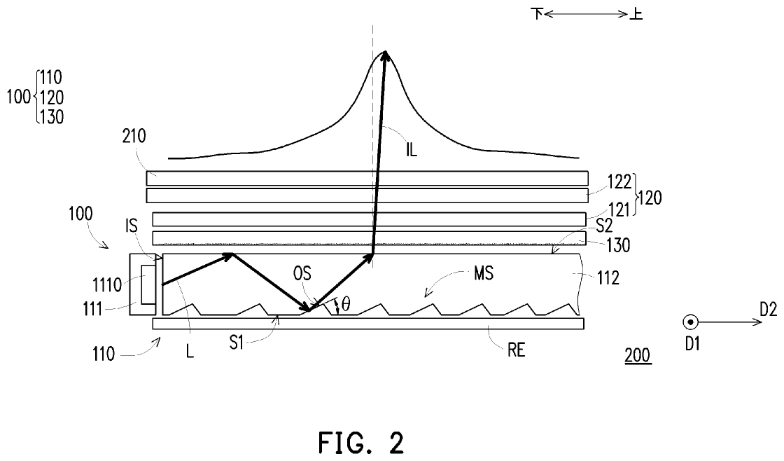

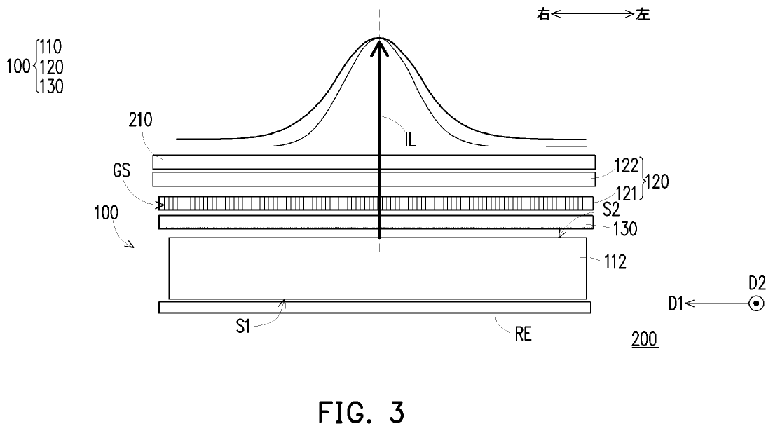

FIG. 1 is a schematic front view of a display device according to an embodiment of the invention. FIG. 2 is a schematic cross-sectional view of the display device depicted in FIG. 1 in a vertical direction. FIG. 3 is a schematic cross-sectional view of the display device depicted in FIG. 1 in a horizontal direction. With reference to FIG. 1 to FIG. 3, in the present embodiment, a display device 200 includes an anti-peep light source module 100 and a display panel 210. The anti-peep light source module 100 includes a light source module 110, a viewing angle switching module 120, and at least one optical film 130. The light source module 110 has a light source 111, a light guide plate (LGP) 112, and a reflective element RE, and the light source 111 has a plurality of light emitting elements 1110 and may be configured to provide a light beam L. For instance, as shown in FIG. 1, in the present embodiment, the light source 111 may be a light bar. According to FIG. 1, the light emitting elements 1110 are arranged along a first direction D1 (i.e., an extension direction of the light bar). The light emitting elements 1110 may be light emitting diodes (LEDs).

The LGP 112 has a light incidence surface IS, a first surface S1, and a second surface S2 opposite to the first surface S1, where the light incidence surface IS is located between the first surface S1 and the second surface S2 to connect the first surface S1 and the second surface S2. Particularly, in the present embodiment, the first surface S1 is a bottom surface of the LGP 112 and faces the reflective element RE, the second surface S2 is a light exit surface and faces the viewing angle switching module 120, and the first direction D1 is parallel to the light incidence surface IS of the LGP 112.

To be more specific, as shown in FIG. 2, in the present embodiment, the LGP 112 has a plurality of optical microstructure MS on the first surface S1. A light receiving angle exists between the first surface S1 and optical surfaces OS of the optical microstructure MS, and the light receiving angle is within a range from 162 degrees to 177 degrees. A supplementary angle of the light receiving angle is an effective optical angle θ of the optical microstructures, and the effective optical angle θ is about 3 degrees to 18 degrees. In addition, according to the present embodiment, as long as the effective optical angle θ is within the range of 3 degrees to 18 degrees, the contour of the optical surfaces OS of the optical microstructures MS of the LGP 112 is not limited to a plane and may also be designed as a curved surface. The light beam L from the light source 111 leaves the second surface S2 of the LGP 112 through the optical surfaces OS of the optical microstructures MS of the LGP 112 and generates an illumination beam IL. Here, since the light receiving angle of the optical microstructures MS is larger than an angle of the microstructures of the normal light source module 110, the effective optical angle θ of the optical microstructures MS is smaller; therefore, as shown in FIG. 2, a light emitting angle of the illumination beam IL is not concentrated on a normal direction of the LGP 112 and may be slightly deviated, which may be conducive to improvement of the brightness of the illumination beam IL within the viewing angle range in various directions of the display device 200, and thereby the range of user's vision may be expanded.

On the other hand, as shown in FIG. 2 and FIG. 3, in the present embodiment, the viewing angle switching module 120 is located on a transmission path of the illumination beam IL and includes a viewing angle limiting element 121 and a viewing angle adjusting element 122, where the viewing angle limiting element 121 is located between the viewing angle adjusting element 122 and the light source module 110. As shown in FIG. 2 and FIG. 3, the viewing angle limiting element 121 has a grating structure GS, and an included angle range between an extension direction D2 of the grating structure GS and the first direction D1 is within a range from 88 degrees to 92 degrees. In the present embodiment, the included angle between the extension direction D2 and the first direction D1 of the grating structure GS is, for instance, 90 degrees. Through the arrangement of the grating structure GS, as shown in FIG. 3, the viewing angle range of the illumination beam IL in a horizontal direction of the display device 200 (i.e., an angle of vision in the left and right directions of the user's vision) may be firstly narrowed. Since the extension direction D2 of the grating structure GS is substantially parallel to a vertical direction of the display device 200 (i.e., the upper and lower directions of the user's vision), the viewing angle of the illumination beam IL in the vertical direction of the display device 200 is not narrowed.

According to the present embodiment, the viewing angle adjusting element 122 is, for instance, a liquid crystal panel and may switch the viewing angle range of the illumination beam IL by controlling electric signals and simultaneously switch the viewing angle range of the illumination beam IL in the horizontal direction and the vertical direction of the display device 200 (i.e., the angle of vision in the left and right directions and the upper and lower directions of the user's vision), e.g., from a wide light emitting viewing angle to a narrow light emitting viewing angle. To be specific, as shown in FIG. 2 and FIG. 3, in the present embodiment, the display panel 210 is located on the transmission path of the illumination beam IL, and the display panel 210 is located on one side of the viewing angle limiting element 121 away from the LGP 112, where the viewing angle adjusting element 122 is located between the display panel 210 and the viewing angle limiting element 121. Thereby, after the illumination beam IL passes through the display panel 210, a display beam may be formed to display an image frame. When the anti-peep light source module 100 controls the viewing angle adjusting element 122 and switches it from the wide light emitting viewing angle to the narrow light emitting viewing angle, a light emitting viewing angle range of the display beam later generated by the illumination beam IL passing through the display panel 210 is also significantly narrowed. As a result, others on the side are unable to clearly see the images on the display device 200 at this time, and thus the display device 200 is in the anti-peep mode and may achieve the privacy protection effects.

Based on the above, in the anti-peep light source module 100 and the display device 200, the brightness of the illumination beam IL within the viewing angle range in various directions of the display device 200 may be expanded through the arrangement of the range of the light receiving angle of the optical microstructures MS of the LGP 112, and thereby the range of the user's vision may be expanded. Besides, the illumination beam IL may have a relatively large forward luminance within the viewing angle range in the horizontal direction of the display device 200 through the arrangement of the viewing angle limiting element 121 without deteriorating the brightness of the illumination beam IL within the viewing angle range in the vertical direction of the display device 200, and the switching of the viewing angle range between the normal mode and the anti-peep mode may be realized through controlling the viewing angle adjusting element 122. Accordingly, the optical performance and the user experience of the anti-peep light source module 100 and the display device 200 may both be taken into account.

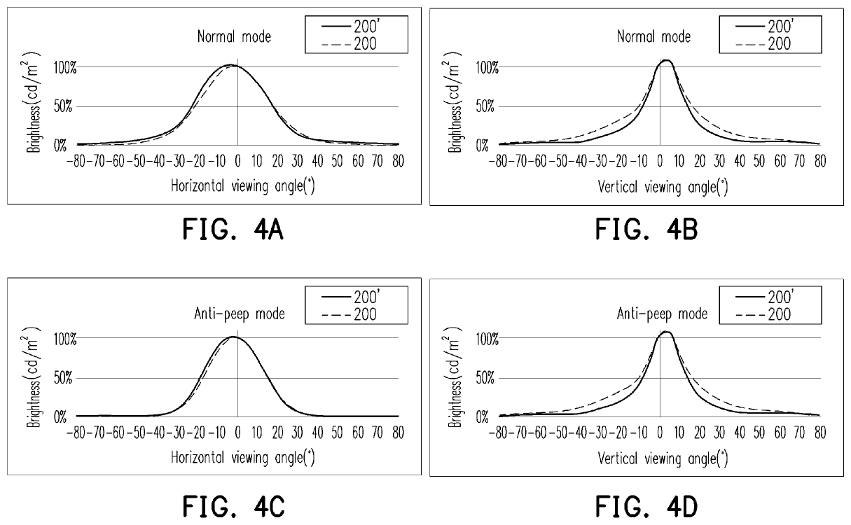

The effects are further explained below with reference to FIG. 4A to FIG. 4D.

FIG. 4A and FIG. 4B are curve diagrams illustrating a relationship between a viewing angle and a brightness of the display device 200 depicted in FIG. 1 and a viewing angle and a brightness of a display device 200′ in a comparison example in a horizontal direction and a vertical direction when the display devices 200 and 200′ are in a normal mode. FIG. 4C and FIG. 4D are curve diagrams illustrating the relationship between the viewing angle and the brightness of the display device 200 depicted in FIG. 1 and the viewing angle and the brightness of the display device 200′ in the comparison example in the horizontal direction and the vertical direction when the display devices 200 and 200′ are in an anti-peep mode. In the present embodiment, the display device 200′ provided in the comparison example is substantially the same as the display device 200 provided in one or more embodiments of the invention, where the light receiving angle of the optical microstructure MS of the display device 200′ provided in the comparison example is greater than 177 degrees, its effective optical angle θ is less than 3 degrees, and the display device 200′ is not equipped with the viewing angle limiting element 121. As shown in FIG. 4A to FIG. 4B, in the normal mode, a full width at half maximum (FWHM) of a brightness curve of the display device 200 at different viewing angles in the horizontal direction is not significantly different from that of the display device 200′ provided in the comparison example; however, the FWHM of the brightness curve of the display device 200 at different viewing angles in the vertical direction is apparently wider than that of the display device 200′ provided in the comparison example. This means that there is no significant difference between the viewing angle range of the display device 200 and the display device 200′ provided in the comparison example in the horizontal direction, while in the vertical direction the viewing angle range of the display device 200 is greater than that of the display device 200′ provided in the comparison example. On the other hand, in the anti-peep mode, the display device 200 has similar performance to that of the display device 200′ provided in the comparison example. The viewing angle range of the display device 200 and that of the display device 200′ provided in the comparison example have no significant difference in the horizontal direction, while in the vertical direction the viewing angle range of the display device 200 is apparently greater than that of the display device 200′ provided in the comparison example. As such, the viewing angle range in the vertical direction may be effectively expanded regardless of whether user is in the normal mode or the anti-peep mode, and the display device 200 may also have the same anti-peep performance, so that the user may have a favorable user experience.

In addition, the viewing angle adjusting element 122 provided in the previous embodiment is located between the display panel 210 and the viewing angle limiting element 121, which should however not be construed as a limitation in the disclosure. In another embodiment not shown in the drawings, the display panel 210 may also be located between the viewing angle adjusting element 122 and the viewing angle limiting element 121. If so, the illumination beam IL generates the display beam first, and the viewing angle adjusting element 122 is configured to switch the light emitting viewing angle range of the display beam, so as to provide the normal viewing mode at a wide viewing angle and the anti-peep mode at a narrow viewing angle. As such, the display device 200 is still able to perform the aforesaid functions and achieve similar achieve similar effects, which will not be repeated hereinafter.

In addition, as shown in FIG. 2 to FIG. 3, the anti-peep light source module 100 further includes at least one optical film 130. According to FIG. 2 to FIG. 3, the at least one optical film 130 is located on the transmission path of the illumination beam IL, where the viewing angle limiting element 121 is located between the at least one optical film 130 and the viewing angle adjusting element 122, and the at least one optical film 130 is located between the viewing angle limiting element 121 and the light source module 110 and is disposed on a surface of the viewing angle limiting element 121 facing the light source module 110. For instance, in the present embodiment, the at least one optical film 130 may be a reflective dual brightness enhancement film, which allows the illumination beam IL that has a specific polarization state and would otherwise be absorbed by the viewing angle adjusting element 122 or the display panel 210 to be reflected to change the polarization state and be effectively re-used, whereby the overall display brightness is improved, and the optical performance of the anti-peep light source module 100 and the display device 200 may be enhanced.

In addition, in the present embodiment, the surface of the at least one optical film 130 facing the light source module 110 is provided with rough structures or diffusion particles, and a haze of the surface of the at least one optical film 130 facing the light source module 110 is within a range from 3% to 30%. Since the at least one optical film 130 is designed to have the proper haze, the anti-peep light source module 100 and the display device 200 may satisfy the requirements for brightness and flaw concealment, and favorable optical performance and production yield may be ensured at the same time.

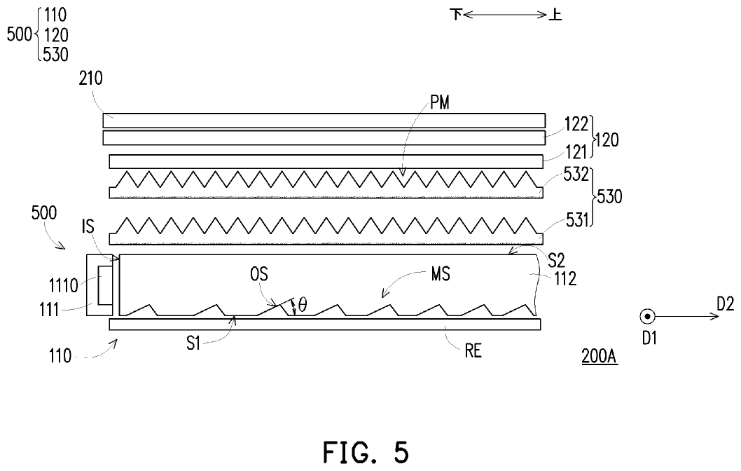

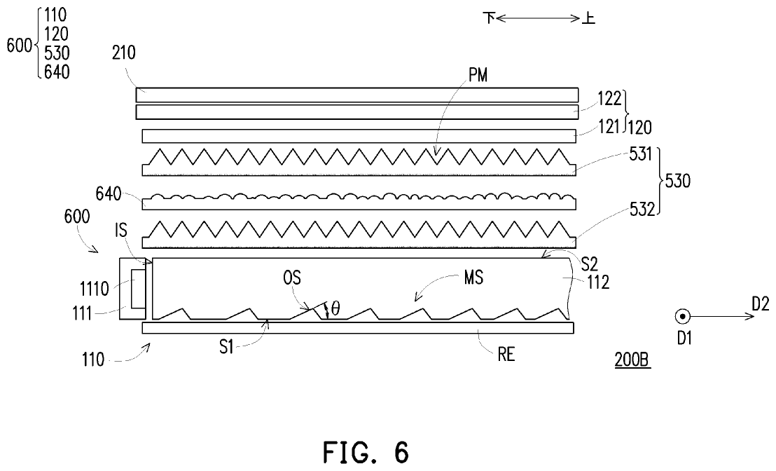

Additionally, in other embodiments, note that the at least one optical film 130 may further enhance the flaw concealing property of the anti-peep light source module and the display device through a combination of different types of brightening films or diffusion sheets, and the production yield may also be improved. Further explanation will be provided below with reference to FIG. 5 and FIG. 6.

FIG. 5 is a schematic structural view of a display device according to another embodiment of the invention. A display device 200A and an anti-peep light source module 500 provided in this embodiment are respectively similar to the display device 200 and the anti-peep light source module 100 shown in FIG. 2, while the differences therebetween are described below. With reference to FIG. 5, in the present embodiment, at least one optical film 530 may be a brightness enhancement film having a plurality of prism structures PM, and the prism structures PM are disposed on a surface of each of the at least one optical film 530 facing the viewing angle limiting element 121. In the present embodiment, an included angle between the first direction D1 and an extension direction of the prism structures PM of the at least one optical film 530 is within a range from 0 degree to ±30 degrees, and an included angle between the extension direction of the prism structures PM of the at least one optical film 530 and the extension direction of the grating structure GS of the viewing angle limiting element 121 is within a range from 60 degrees to 120 degrees. Through the arrangement of the prism structures PM, the overall display brightness may also be improved, thereby improving the optical performance of the anti-peep light source module 100 and the display device 200.

Further, the at least one optical film 530 includes a first optical film 531 and a second optical film 532, where the included angle between the extension direction of the prism structures PM of the first optical film 531 and the extension direction of the prism structures PM of the second optical film 532 is within a range from 2 degrees to 10 degrees. Since the extension direction of the prism structures PM of the first optical film 531 is inconsistent with the extension direction of the prism structures PM of the second optical film 532, interference fringes may be prevented.

Besides, in the present embodiment, the first optical film 531 is located between the second optical film 532 and the light source module 110, wherein a refractive index of the first optical film 531 is smaller than a refractive index of the second optical film 532. For instance, according to the refractive index of the existing optical films, the lower limit of the refractive index of the at least one optical film 530 may be within a range from 1.48 to 1.55; therefore, the lower limit of the refractive index of the first optical film 531 may be greater than or equal to 1.48, and the lower limit of the refractive index of the second optical film 532 may be greater than or equal to 1.55. In addition, according to the present embodiment, rough structures or diffusion particles may be formed on the surface of each of the at least one optical film 530 (i.e., the first optical film 531 and the second optical film 532) facing the light source module 110, and a haze of the surface of each of the at least one optical film 530 facing the light source module 110 is within a range from 3% to 30%. As such, since the at least one optical film 530 has one surface equipped with the prism structures PM and the other surface with the proper haze, the anti-peep light source module 500 and the display device 200A may satisfy the requirements for brightness and flaw concealment, and favorable optical performance and production yield may be ensured at the same time.

In addition, in the present embodiment, the anti-peep light source module 500 and the anti-peep light source module 100 have similar structures in terms of the light receiving angle and the viewing angle switching module 120; hence, the anti-peep light source module 500 and the display device 200A may also perform similar functions to those of the anti-peep light source module 100 and the display device 200 shown in FIG. 2A, thereby achieving similar effects and advantages, which will not be repeated hereinafter.

FIG. 6 is a schematic structural view of a display device according to still another embodiment of the invention. A display device 200B and an anti-peep light source module 600 provided in this embodiment are respectively similar to the display device 200A and the anti-peep light source module 500 shown in FIG. 5, while the differences therebetween are described below. With reference to FIG. 6, in the present embodiment, the surface of each optical film 530 (i.e., the first optical film 531 and the second optical film 532) facing the light source module 110 is not equipped with any rough structures or diffusion particles; instead, in the present embodiment, the anti-peep light source module 600 further includes a diffusion sheet 640 located between the first optical film 531 and the second optical film 532, and a haze of a surface of the diffusion sheet 640 is within a range from 3% to 30%. As such, since the at least one optical film 530 includes the diffusion sheet 640 and the first optical film 531 and the second optical film 532 with the prism structures PM, the anti-peep light source module 600 and the display device 200B may satisfy the requirements for brightness and flaw concealment, and favorable optical performance and production yield may be ensured at the same time.

In addition, in the present embodiment, the anti-peep light source module 600 and the anti-peep light source module 500 have similar structures in terms of the light receiving angle and the viewing angle switching module 120; hence, the anti-peep light source module 600 and the display device 200B may also perform similar functions to those of the anti-peep light source module 500 and the display device 200A shown in FIG. 5, thereby achieving similar effects and advantages, which will not be repeated hereinafter.

To sum up, in the anti-peep light source module and the display device provided in one or more embodiments of the Invention, the brightness of the illumination beam within the viewing angle range in various directions of the display device may be expanded through the arrangement of the range of the light receiving angle of the optical microstructures of the LGP, and thereby the range of the user's vision may be expanded. Besides, the illumination beam may have a relatively large forward luminance within the viewing angle range in the horizontal direction of the display device through the arrangement of the viewing angle limiting element without deteriorating the brightness of the illumination beam within the viewing angle range in the vertical direction of the display device, and the switching of the viewing angle range between the normal mode and the anti-peep mode may be realized through controlling the viewing angle adjusting element. Accordingly, the optical performance and the user experience of the anti-peep light source module may both be taken into account. Moreover, since the at least one optical film is designed to have the proper haze, the anti-peep light source module and the display device provided in one or more embodiments of the invention may satisfy the requirements for brightness and flaw concealment, and favorable optical performance and production yield may be ensured at the same time. As such, the anti-peep light source module and the display device provided in one or more embodiments of the invention may have the favorable optical performance, the user experience, and the production yield.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the invention is provided to comply with the rules requiring an abstract, which will allow a searcher to quickly ascertain the subject matter of the technical disclosure of any patent issued from this invention. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the invention is intended to be dedicated to the public regardless of whether the element or component is explicitly recited in the following claims.

What is claimed is:

1. An anti-peep light source module, comprising:
a light source module, having a light source and a light guide plate, wherein the light source is configured to provide a light beam and has a plurality of light emitting elements, the plurality of light emitting elements are arranged along a first direction, the first direction is parallel to a light incidence surface of the light guide plate, the light guide plate has a plurality of optical microstructures on a first surface of the light guide plate, the light beam leaves a second surface of the light guide plate through optical surfaces of the plurality of optical microstructures of the light guide plate and generates an illumination beam, and the light incidence surface is located between the first surface and the second surface; and
a viewing angle switching module, located on a transmission path of the illumination beam and comprising:
a viewing angle limiting element, having a grating structure, wherein an included angle between an extension direction of the grating structure and the first direction is within a range from 88 degrees to 92 degrees; and
a viewing angle adjusting element, configured to change a viewing angle range of the illumination beam, wherein the viewing angle limiting element is located between the viewing angle adjusting element and the light source module.

2. The anti-peep light source module according to claim 1, wherein the optical surfaces of each of the plurality of optical microstructures and the first surface has a light receiving angle, and the light receiving angle is within a range from 162 degrees to 177 degrees.

3. The anti-peep light source module according to claim 1, further comprising:
at least one optical film, located on the transmission path of the illumination beam, wherein the viewing angle limiting element is located between the at least one optical film and the viewing angle adjusting element, and the at least one optical film is located between the viewing angle limiting element and the light source module.

4. The anti-peep light source module according to claim 3, wherein each of the at least one optical film has a plurality of prism structures, and the plurality of prism structures are disposed on a surface of each of the at least one optical film facing the viewing angle limiting element.

5. The anti-peep light source module according to claim 4, wherein an included angle between an extension direction of the plurality of prism structures and the first direction is within a range from 0 degree to ±30 degrees.

6. The anti-peep light source module according to claim 4, wherein an included angle between an extension direction of the plurality of prism structures and the extension direction of the grating structure of the viewing angle limiting element is within a range from 60 degrees to 120 degrees.

7. The anti-peep light source module according to claim 4, wherein the at least one optical film comprises a first optical film and a second optical film, and an included angle between an extension direction of the plurality of prism structures of the first optical film and an extension direction of the plurality of prism structures of the second optical film is within a range from 2 degrees to 10 degrees.

8. The anti-peep light source module according to claim 7, wherein the first optical film is located between the second optical film and the light source module, and a refractive index of the first optical film is smaller than a refractive index of the second optical film.

9. The anti-peep light source module according to claim 7, further comprising:
a diffusion sheet, located between the first optical film and the second optical film, and a haze of a surface of the diffusion sheet is within a range from 3% to 30%.

10. The anti-peep light source module according to claim 3, wherein a plurality of rough structures or a plurality of diffusion particles are arranged on a surface of each of the at least one optical film facing the light source module, and a haze of the surface of each of the at least one optical film facing the light source module is within a range from 3% to 30%.

11. A display device, comprising:
an anti-peep light source module, comprising:
a light source module, having a light source and a light guide plate, wherein the light source is configured to provide a light beam and has a plurality of light emitting elements, the plurality of light emitting elements are arranged along a first direction, the first direction is parallel to a light incidence surface of the light guide plate, the light guide plate has a plurality of optical microstructures on a first surface of the light guide plate, the light beam leaves a second surface of the light guide plate through optical surfaces of the plurality of optical microstructures of the light guide plate and generates an illumination beam, and the light incidence surface is located between the first surface and the second surface; and
a viewing angle switching module, located on a transmission path of the illumination beam and comprising:
a viewing angle limiting element, having a grating structure, wherein an included angle between an extension direction of the grating structure and the first direction is within a range from 88 degrees to 92 degrees; and
a viewing angle adjusting element, configured to change a viewing angle range of the illumination beam, wherein the viewing angle limiting element is located between the viewing angle adjusting element and the light source module; and
a display panel, located on the transmission path of the illumination beam and located on one side of the viewing angle limiting element away from the light guide plate.

12. The display device according to claim 11, wherein the display panel is located between the viewing angle adjusting element and the viewing angle limiting element.

13. The display device according to claim 11, wherein the viewing angle adjusting element is located between the display panel and the viewing angle limiting element.
